(19) United States
(12) Patent Application Publication
(10) Pub. No.: US 2025/0307635 A1
(43) Pub. Date: Oct. 2, 2025

(54) TRAINING METHOD AND APPLICATION METHOD OF NEURAL NETWORK MODEL, TRAINING APPARATUS AND APPLICATION APPARATUS OF NEURAL NETWORK MODEL, STORAGE MEDIUM, AND COMPUTER PROGRAM PRODUCT

(71) Applicant: CANON KABUSHIKI KAISHA, Tokyo (JP)

(72) Inventors: Lingxiao Yin, Beijing (CN); Wei Tao, Beijing (CN); Tsewei Chen, Tokyo (JP); Dongyue Zhao, Beijing (CN); Siran Peng, Beijing (CN)

(21) Appl. No.: 19/085,829

(22) Filed: Mar. 20, 2025

(30) Foreign Application Priority Data
Mar. 26, 2024 (CN) 202410357148.4

(51) Int. Cl. G06N 3/082; G06N 3/0495

(52) U.S. Cl. CPC G06N 3/082; G06N 3/0495

(57) ABSTRACT

The present disclosure provides a training method and an application method of a neural network model, a training apparatus and an application apparatus of a neural network model, a storage medium, and a computer program product. The training method comprises: a pre-training step of pre-training the neural network model so that the neural network model includes at least one quantization unit, wherein each quantization unit contains a plurality of different quantization bit widths; a calculation step of calculating a sensitivity of the quantization unit, and updating the quantization bit width of each quantization unit based on the calculated sensitivity and updating a quantization parameter, thereby generating a mixed-precision neural network model, wherein the sensitivity indicates the extent to which the quantization bit width of the quantization unit affects a network output; and a retraining step of retraining the generated mixed-precision neural network model.

### CROSS REFERENCE TO RELATED APPLICATIONS

This nonprovisional application claims the benefit of Chinese Patent Application No. 202410357148.4 filed on Mar. 26, 2024 which is hereby incorporated by reference herein in its entirety.

### TECHNICAL FIELD

The present disclosure relates to the field of modeling of Deep Neural Networks (DNNs) models.

### BACKGROUND

A deep neural network model, in the field of artificial intelligence, is a model with complex network architecture. It is also one of the most widely used architectures at present. The common neural network models include Convolutional Neural Network (CNN) models, etc. Deep neural network models are widely used in the fields of computer vision, computer hearing, and natural language processing, such as image classification, object recognition and tracking, image segmentation, and speech recognition. There are a large number of learnable parameters in the deep neural network models. The linear processing units and nonlinear processing units inside the deep neural network models are connected crosswise, which makes possible a complicated topological relationship and is able to characterize any complex function. After a specific learning process, the deep neural network models can have powerful recognition and generalization capabilities.

Furthermore, running deep neural network models require a good deal of memory overhead and abundant processor resources. Although the deep neural network models can achieve better performance goals on GPU-based workstations or servers, they are usually not suitable for running on resource-limited embedded devices, such as smartphones, tablets, and various handheld devices.

To resolve the above problems, the following several solutions may typically be adopted to optimize the models:

Pruning/sparsity: in the process of training the network, unimportant connection relations are cut out, and most of the weights in the network become 0, so that the model is stored in a sparse mode. Pruning may be implemented at different levels, such as weight level, channel level, and layer level, depending upon the task.

Low-rank factorization: the low-rank factorization is performed using structured matrices, such that full-rank matrix which is originally dense can be expressed as a combination of several low-rank matrices, and the low-rank matrix may further be factorized into a product of small-scale matrices.

Quantization: a lower bit width (1 bit, 2 bits or 8 bits) is used to represent a floating point number with 32-bit or more precision, so that the network parameters and the consecutive real values in a feature map are mapped onto discrete integer values to significantly reduce the storage space of parameters and memory footprint, speed up computation, and reduce the power consumption of the device.

Knowledge distillation: Unlike pruning and quantization in model compression, knowledge distillation is to train a small model by constructing a lightweight small model and taking advantage of the supervisory information from a large model with better performance in the hope of achieving better performance and precision. Specifically, the knowledge of a large network with good performance is transferred to a small network via transfer learning, so that the small network model achieves comparable performance to the large model, which could reduce the computational cost.

Design of a lightweight model architecture (compact model architecture): A specially structured network layer is constructed and trained from scratch to obtain network performance suitable for deployment to resource-limited device without a need for special storage of a pre-trained model or fine-tuning to improve the performance, which reduces the time cost and is featured in a small amount of storage, low computational complexity, and good network performance.

Among the above several technical solutions, in the above five technical solutions, since low-precision calculations can simultaneously reduce memory footprint, increase throughput, and reduce latency of deep neural network inference, deep neural network quantization is becoming increasingly important in reducing energy and memory footprint of deep neural networks. In practical applications, a higher quantization bit width will produce a lower quantization error, but the latency of the deep neural network inference is higher. In order to reduce the quantization error and achieve a balance between efficiency and precision, the automatic determination of optimal hierarchical precision allocation according to neural network search techniques has shown good results.

The prior art has proposed a framework for searching mixed-precision networks, as described in Zhaowei Cai, Nuno Vasconcelos, “Rethinking Differentiable Search for Mixed-Precision Neural Networks”, with the following characteristics: a differentiable search algorithm-based; in order to avoid a trivial choice of the highest bit width, a complexity-budgeted loss is added to a total loss function to constrain the learning process; learnable parameters of the network and weighting parameters of the bit width are learned simultaneously; a weighted sum of the quantized inputs is applied as a new input and a weighted sum of the quantized weights is applied as a new kernel weight, so that the convolution operator performs the calculation as usual without additional computational cost. The method adds a complexity constraint to the task loss and multiplies it by a Lagrange multiplier. However, the dimension of the weight is too large to accurately calculate the Lagrange multiplier, and therefore, expert experience must be equipped, which will cost a lot of resources. The search results largely depend on the complexity constraint, i.e. the Lagrange multiplier, and thus the final convergent search results will not accurately satisfy the computational cost constraint.

CN111898751A proposes a data processing method comprising the following steps: describing each of markers in a network model at an essential level or a non-essential level according to obtained structure information of the network model; determining a quantization bit width range at the essential level and a quantization bit width range at the non-essential level respectively according to information of hardware sources to be deployed; determining optimal quantization bit widths of each network models within the quantization bit width range; training the network model based on the optimal quantization bit widths of each network models to obtain an optimal network model, and performing data processing with the optimal network model. The granularity of the bit width used in this method is larger, and it has only two types of layers: basic layers and non-basic layers for determining bit width allocation in the network. The allocation of quantization bit width between layers is based on a full-precision model, and does not take the effect of the distribution of quantized data into account. When grouping the basic layers and the non-basic layers, thresholds need to be designed manually. It is necessary to use the information of hardware sources that requires complex calculations to determine bit width ranges of the basic layers and the non-basic layers.

### SUMMARY

The present disclosure provides a training method of a neural network, by which a high-precision neural network model satisfying computational overhead constraint can be searched out under the limited condition of search overhead.

According to one aspect of the present disclosure, there is provided a method for training a neural network model, the method comprising: a pre-training step of pre-training the neural network model so that the neural network model includes at least one quantization unit, wherein each quantization unit contains a plurality of different quantization bit widths; a calculation step of calculating a sensitivity of the quantization unit, and based on the calculated sensitivity updating the quantization bit width of each quantization unit and updating a quantization parameter, thereby generating a mixed-precision neural network model, wherein the sensitivity indicates the extent to which the quantization bit width of the quantization unit affects a network output; and a retraining step of retraining the generated mixed-precision neural network model.

According to another aspect of the present disclosure, there is provided an application method of a neural network model, comprising: storing a neural network model trained based on the method for training described above; receiving a dataset corresponding to a requirement of a task executable by the stored neural network model; and performing operations on the dataset in each layer of the stored neural network model from top to bottom, and outputting a result.

According to another aspect of the present disclosure, there is provided an application apparatus of a neural network model, comprising: a storage module configured to store a neural network model trained based on the method for training described above; a receiving module configured to receive a dataset corresponding to a requirement of a task executable by a stored neural network model; and a processing module configured to perform operations on the dataset in each layer of the stored neural network model from top to bottom, and output a result.

According to another aspect of the present disclosure, there is provided a non-transitory computer-readable storage medium storing instructions which, when executed by a computer, cause the computer to perform the method for training the neural network model described above.

Other features of the present disclosure will become apparent from the following description of the exemplary embodiments with reference to the attached drawings.

### BRIEF DESCRIPTION OF THE DRAWINGS

The drawings, which are incorporated in and constitute part of the description, illustrate exemplary embodiments of the present disclosure and serve to explain, together with the descriptions on the exemplary embodiments, the principles of the present disclosure.

FIG. 1 shows a block diagram of a hardware configuration according to an exemplary embodiment of the present disclosure.

FIG. 2 shows a flowchart of a training method of a neural network model according to the first exemplary embodiment of the present disclosure.

FIG. 3 shows neural network model architecture.

FIG. 4 and FIG. 5 show a flowchart of a training method of a neural network model according to the first exemplary embodiment of the present disclosure.

FIG. 6 shows a schematic diagram of a training system according to the second exemplary embodiment of the present disclosure.

FIG. 7 shows a schematic diagram of a training apparatus according to the third exemplary embodiment of the present disclosure.

### DETAILED DESCRIPTION

Exemplary embodiments of the present disclosure will be described hereinafter with reference to the drawings. For the purpose of being clear and concise, not all of the non-essential features that could be included in the embodiments are described. However, it should be appreciated that it is necessary to make numerous configurations specific to respective embodiments in implementation of the embodiments, so as to realize the specific target of the developing personnel. For example, restrictions associated with device and business may be satisfied; and the restrictions may vary according to different embodiments. In addition, it should be appreciated that although the development work may be very complicated and time consuming, in view of the contents of the present disclosure such development work could be routine for a person skilled in the art

It should also be noted herein that in order not to obscure the description of the present disclosure with unnecessary details, the accompanying drawings only show the processing steps and/or system structures of close concern at least according to the solution of the present disclosure; other details less associated with the present disclosure are omitted.

### (Hardware Configuration)

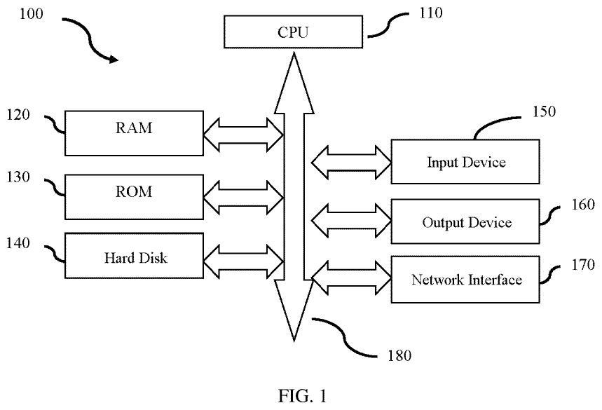

First, a hardware configuration (for example, digital camera) capable of implementing the techniques described below is described with reference to FIG. 1.

The hardware configuration 100 includes, for example, a Central Processing Unit (CPU) 110, a Random Access Memory (RAM) 120, a Read-Only Memory (ROM) 130, a hard disk 140, an input device 150, an output device 160, a network interface 170, and a system bus 180. In an implementation, the hardware configuration 100 is implementable by a computer, such as a tablet computer, a laptop computer, a desktop computer, or other suitable electronic devices.

In an implementation, the apparatus for training a neural network model according to the present disclosure is constructed by hardware or firmware and serves as a module or component of the hardware configuration 100. In another implementation, the method for training a neural network model according to the present disclosure is constructed by software stored in the ROM 130 or the hard disk 140 and executed by the CPU 110.

The CPU 110 is any suitable programmable control device (e.g., processor) and may execute various functions described below by executing various applications stored in the ROM 130 or the hard disk 140 (e.g., memory). The RAM 120 is used to temporarily store program or data loaded from the ROM 130 or the hard disk 140 and also used as a space for the CPU 110 to execute various processes and other available functions. The hard disk 140 stores a variety of information such as an Operating System (OS), various applications, a control program, a sample image, a trained neural network model, and predefined data (e.g., thresholds THs).

In an implementation, the input device 150 is configured to enable a user to interact with the hardware configuration 100. In an example, the user may input a sample image and a label of the sample image (e.g., region information of an object, category information of an object, etc.) via the input device 150. In a further instance, the user may trigger a corresponding process of the present disclosure via the input device 150. In addition, the input device 150 may take a variety of forms, such as a button, a keyboard, or a touch panel.

In an implementation, the output device 160 is configured to store a final trained neural network model into, for example, the hard disk 140 or to output the final generated neural network model to subsequent image processing such as object detection, object classification, image segmentation.

The network interface 170 provides an interface for connecting the hardware configuration 100 to the network. For example, the hardware configuration 100 may perform data communication via the network interface 170 with other electronic devices connected via the network. Optionally, a wireless interface may be provided for the hardware configuration 100 for wireless data communication. The system bus 180 may provide a data transmission path for mutual data transmission among the CPU 110, the RAM 120, the ROM 130, the hard disk 140, the input device 150, the output device 160, the network interface 170, and the like. Although referred to as a bus, the system bus 180 is not limited to any specific data transmission technique.

The above-mentioned hardware configuration 100 is merely illustrative. It is not intended to limit the present disclosure or the application or use thereof. In addition, for the sake of conciseness, FIG. 1 illustrates only one hardware configuration. Nonetheless, multiple hardware configurations may be utilized as needed. Moreover, multiple hardware configurations may be connected via a network. In that case, the multiple hardware configurations may be implemented, for example, by a computer (e.g., cloud server) or by an embedded device, such as a camera, a video camera, a Personal Digital Assistant (PDA) or other suitable electronic devices.

Next, various aspects of the present disclosure are described.

### First Exemplary Embodiment

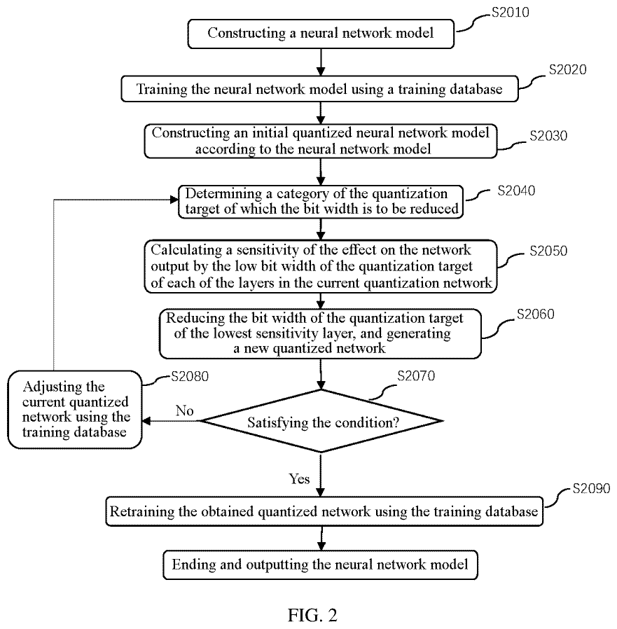

A training method for training a neural network model according to the first exemplary embodiment of the present disclosure will be described hereinafter with reference to FIG. 2 through FIG. 5. The training method is described in detail below. The first embodiment shows the main workflow described in the present disclosure of searching for a neural network model with a smaller bit width.

Referring to FIG. 2, the training method is described in detail below.

Step S2100: constructing a neural network model.

Specifically, in this step, a neural network model is created according to a specific task target requirement, for example, tasks such as image classification and instance segmentation; an existing neural network model may be optionally used, or the neural network model may be obtained by a generic search method, for example, DARTS, etc. On this basis, corresponding quantization targets are constructed for all layers in the current neural network, and all possible bit width pathways are constructed for each of the quantization targets, so as to construct a desired neural network model. This process can be regarded as an initialization process of the neural network model.

Step S2200: training the neural network model generated in S2100 using a training database

Training of a neural network model is a cyclic and repetitive process. Each iteration involves three processes: forward calculation, backward calculation, and parameter update. Among them, forward calculation is to input a batch of data to be trained into the network, perform calculations layer by layer from top to bottom in the network model, and obtain the result of the network output. Backward calculation is a process of calculating a loss function based on the true value of the trained batch of data and the result of the network output, and passing the gradient of the loss function forward from the last layer of the network. Parameter update is mainly to calculate the updated value of the current parameter based on the back-propagated gradient value and the corresponding optimization algorithm. The neural network model is trained in this step until the network converges or the exit condition is satisfied.

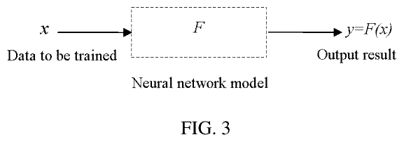

FIG. 3 shows a simple neural network model architecture (without showing the specific network architecture). After a data x (a feature map) to be trained is input into a neural network model F, x is calculated layer by layer from top to bottom in the neural network model F, and finally an output result y that satisfies certain distribution requirements is output from the neural network model F.

In a case that the difference between the actual output result and the desired output result of the neural network model does not exceed a predetermined threshold, this indicates that weights in the neural network model are optimal solutions, and the performance of the trained neural network model has reached the desired performance. Training of the neural network model is therefore completed. Otherwise, in a case that the difference between the actual output result and the desired output result of the neural network model exceeds the predetermined threshold, it is necessary to continue the back propagation process, that is, to perform calculations layer by layer from bottom to top in the neural network model based on the difference between the actual output result and the desired output result so as to update the weights in the model, such that the performance of the network model with the weights updated is closer to the desired performance.

The neural network model applicable to the present disclosure may be any known model, for example, a convolutional neural network model, a recurrent neural network model, a graph neural network model, etc. The present disclosure does not limit the type of the network model.

The computational precision of the neural network model applicable to the present disclosure may be any precision, either high precision or low precision. The term “high precision” and the term “low precision” refer to the relative levels of the precision and are not limited to the specific numerical values. For example, the high precision may be 32-bit floating-point type, and the low precision may be 1-bit fixed-point type. Of course, other precisions such as 16-bit, 8-bit, 4-bit, 2-bit precisions are also included in the scope of computational precision applicable to the solution of the present disclosure. The term “computational precision” may refer to precision of the weight in the neural network model or precision of the input x to be trained, which is not limited in the present disclosure. The neural network models according to the present disclosure may be Binary Neural Networks (BNNs) models, and are of course not limited to the neural network models with the other computational precisions.

Step S2030: constructing an initial quantized neural network model according to the neural network model trained in step S2020.

In this step, according to the neural network model trained in step S2020, the initial quantized neural network model adopts a similar network structure, selects a pathway with maximum bit width for the quantization target of each of its layers, and network parameters of each of the layers are directly inherited from the neural network model trained in step S2020.

Step S2040: determining a category of the quantization target of which the bit width is to be reduced.

In this step, quantization targets of each of the layers are usually divided into filter weights and feature maps. In this step, the quantization targets are selected by a random algorithm to perform the subsequent bit width search, or the quantization targets may be selected by a preset method to perform the subsequent bit width search.

Step S2050: calculating a sensitivity of the effect on the network output by the low bit width of the quantization target of each of the layers in the current quantized neural network model.

In this step, given a group of training data, first, it is input to the current quantized neural network model for forward propagation, and the gradient of the output feature map of its initial last layer is recorded. Next, for the selected quantization target of each of the layers, the current bit width thereof is reduced to an adjacent smaller bit width, and the other layers are kept unchanged, then the training data is input to the quantized neural network model with the reduced bit width for forward propagation, and the gradient of the output feature map of the its corresponding new last layer is recorded; finally, the sensitivity of the quantization target of each of the layers is measured by a change of gradient of the output feature map of the last layer of the network before and after the bit width change. The smaller the change of gradient is, it indicates that the lower the sensitivity of the effect on the network output by the quantization target of this layer. A sensitivity measurement method can use the sum of the absolute values of the changes before and after the gradients are output, which is defined as follows:

$$S ( {layer}_{i} ) = \sum \vert \frac{\partial L ( {layer}_{i} )}{\partial {f}_{L a s t L a y e r}} - \frac{\partial L ( lower ( {layer}_{i} ) )}{\partial {f}_{L a s t L a y e r}} \vert \qquad ( equation 1 )$$

Wherein L is the target function, f_{LastLayer} is the feature map output by the last layer of the network, L(layerᵢ) is the corresponding loss function when the bit width of the quantization target of the i-th layer is not reduced, L(lower(layerᵢ)) is the corresponding loss function when the bit width of the quantization target of the i-th layer is reduced.

In addition, the sensitivity measurement can also define other measurement methods based on gradient information, such as single-shot network pruning (snip), gradient signal preservation (grasp), synaptic flow pruning (synflow), Fisher information, batch normalization scale factor, L2 norm, Jacobian determinant, etc. For example:

$$The calculation equation of the single - shot network pruning ( snip ) is : S ( θ ) = \vert \frac{\partial L}{\partial θ} ⊙ θ \vert \qquad ( equation 2 )$$

The calculation equation of the gradient signal preservation (grasp) is:

$$S ( θ ) = - ( H \frac{\partial L}{\partial θ} ) ⊙ θ \qquad ( equation 3 )$$

The calculation equation of the synaptic flow pruning (synflow) is:

$$S ( θ ) = \frac{\partial L}{\partial θ} ⊙ θ \qquad ( equation 4 )$$

wherein L is the target function, θ is a learnable parameter in the operation, H is a Hesain matrix.

Sensitivity may also be normalized by some indicators. These indicators include the number of floating-point operations, the number of multiply-accumulate operations, the total amount of memory consumption, and the total amount of computational consumption, etc.

Step S2060: reducing the bit width of the quantization target of the lowest sensitivity layer, and generating a new quantized neural network model.

In this step, first, the sensitivities calculated by each of the layers are sorted, and the layer with the lowest sensitivity is selected; then, the bit width of the quantization target of the lowest sensitivity layer is reduced to the adjacent smaller bit width, so as to obtain a new quantized neural network model.

Step S2070: determining whether the current quantized neural network model satisfies the task target.

In this step, the task target may be a calculation amount magnitude, a parameter amount magnitude, and so on of the quantized neural network, and specifically, the number of floating-point operations, the total amount of computational consumption, the total amount of memory consumption, a hardware constraint, a training cost, and so on of the current quantized neural network model. In a case that the current quantized neural network model satisfies the task target, the bit width search process ends, which indicates that a quantized neural network satisfying the condition has been searched out, and the process proceeds to step S2090; otherwise, the process proceeds to step S2080 to repeat(cycle) the search process. A filter weight quantization bit width and a feature map quantization bit width may be obtained in this step, or may be obtained according to a random algorithm or a preset method by repeating(cycling) steps S2080 to S2090 a plurality of times.

Step S2080: adjusting the current quantized neural network model using the training database.

In this step, a part of a training set data is selected, and the current quantized neural network is iteratively trained to achieve the purpose of fine-tuning its parameters.

Step S2090: retraining the quantized neural network model using the training database.

In this step, when the quantized neural network model satisfying the task target has been obtained, the searched out neural network model is retrained according to the specific task requirement and all the training set data, until the network converges or the exit condition is satisfied.

With the solution of the present exemplary embodiment, a high-accuracy quantized neural network model satisfying the computational overhead constraint can be searched out.

According to the present exemplary embodiment, first, one neural network is constructed according to the scenario specification design requirements and the search space. The quantization unit of each of the layers in this network includes all possible quantization bit widths in the bit width search space, i.e. an integrated network structure for all candidate mixed precision network structures. Depending on the target of the task, based on the training set and the labeled data, each quantization unit of each of the layers selects one of the bit widths for quantizing the input during forward propagation; in the reverse gradient calculation, a gradient optimization algorithm is used to iteratively update all parameters of the network model until the network converges or the exit condition is satisfied.

Then, the structure and weight parameters of the above-described network are inherited as the initial quantized neural network model, the sensitivity of the effect on the final output of the network by the quantization unit of each of the layers in the current quantized neural network model is calculated based on the specified sensitivity measurement indicator, and the sensitivities calculated by each of the quantization units are compared and sorted. The quantization unit with the highest sensitivity is selected to adjust its bit width (increase to a larger bit width), so as to obtain a new quantized neural network model, and all learnable parameters of the new quantized neural network model are fine-tuned according to the training set and labeled data of the task. The above search process is iteratively performed until all neural network models that can satisfy the task-related constraints and computational constraints are searched out.

Finally, the finally searched out quantified neural network model is retrained according to all the training sets and labeled data of the task.

According to this exemplary embodiment, a high-accuracy quantized neural network model satisfying the computational overhead constraint can be searched out.

Table 1 to Table 3 are comparisons of technical effects of validation for a classification task on an ImageNet training/evaluation set of the method according to the present exemplary embodiment and the prior art (EdMIPS), the validation being performed using a convolutional neural network architecture RestNet18. Table 1 is a comparison of results for the accuracy for a generic data set of the prior art and the method according to exemplary embodiments of the present disclosure.

TABLE 1

| | Top-1 | Top-5 | BitFlops(*10\hat{ }10) |
|---|---|---|---|
| EdMIPS | 65.9 | 86.5 | 6.73 |
| Method of Present | 65.1 | 86.1 | 6.51 |
| embodiment | | | |

Table 2 is a comparison of bit widths of feature maps of the neural network model obtained according to the prior art and the method of the exemplary embodiment of the present disclosure.

TABLE 2

| | Bit Widths of Feature Maps of the searched |
|---|---|
| | out Model |
| EdMIPS | 2, 2, 2, 2, 2, 2, 4, 2, 2, 3, 3, 3, 2, 2, 3, |
| | 3, 3, 2, 2 |
| Method of Present | 2, 2, 2, 2, 2, 2, 2, 2, 2, 2, 2, 2, 2, 2, 2, |
| embodiment | 2, 2, 2, 2 |

Table 3 is a comparison of bit widths of filters of the neural network model obtained according to the prior art and the method of the exemplary embodiment of the present disclosure.

TABLE 3

| | Comparison of Bit widths of Filters of the |
|---|---|
| | searched out Model |
| EdMIPS | 1, 1, 1, 1, 3, 2, 4, 2, 1, 3, 2, 4, 2, 1, |
| | 3, 2, 4, 2, 2 |
| Method of Present | 4, 1, 1, 1, 3, 2, 4, 2, 1, 3, 2, 4, 2, 1, |
| embodiment | 3, 2, 4, 2, 2 |

Compared with the prior art, the method of the present disclosure has the following advantages:
(1) The method according to an exemplary embodiment of the present disclosure does not need to allocate hyper-parameters that affect the bit width allocation result.
(2) In the method according to the exemplary embodiment of the present disclosure, the adjustment of the quantization bit width is based on a well-converged quantized neural network model with minimal interference to model precision.
(3) The final quantization bit width allocation result of the method according to the exemplary embodiment of the present disclosure can satisfy the goal of computational overhead.

Accordingly, the mixed-precision neural network search method with hierarchical precision allocation according to this exemplary embodiment is capable of searching out a high-precision neural network model satisfying a computational overhead constraint under the limited condition of search overhead.

### Modification 1

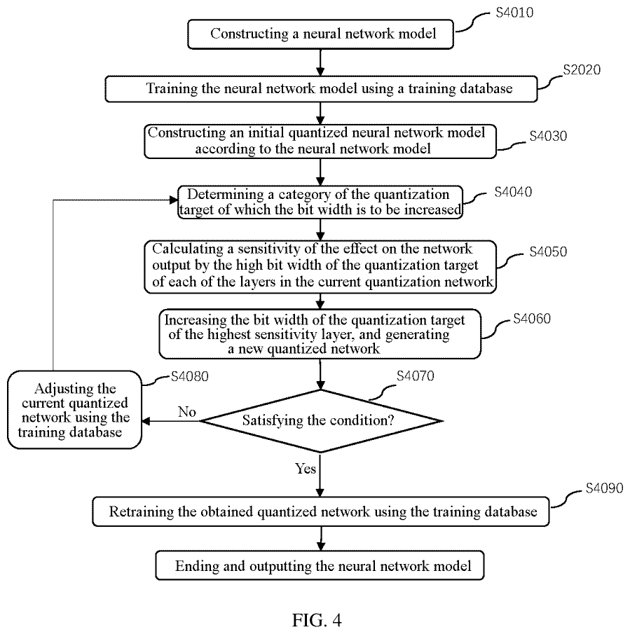

The training method of the neural network model in this exemplary embodiment will be described below with reference to FIG. 4. This exemplary embodiment shows the main workflow of searching for a neural network model with a larger bit width. The training method is described in detail below.

Step S4010: similarly to step S2010, constructing a neural network model in this step.

Step S4020: similarly to step S2020, training the neural network model constructed in step S4010 using a training database in this step.

Step S4030: constructing an initial quantized neural network model structure according to the neural network model.

In this step, according to the neural network model trained in step S4030, the constructed initial quantized neural network model adopts a similar network structure, and is different from the above-described exemplary embodiment in that a pathway having a minimum bit width is selected for the quantization target of each of the layers thereof, and the network parameters of each of the layers are directly inherited from the neural network model.

Step S4040: determining a category of the quantization target of which the bit width is to be increased.

The quantization targets of each of the layers are usually divided into filter weights and feature maps. In this step, the quantization targets are selected in a cyclic alternating manner to perform the subsequent bit width search.

Step S4050: calculating a sensitivity of the effect on the network output by the high bit width of the quantization target of each of the layers in the current quantized neural network model.

In this step, given a group of training data, first, it is input to the current quantized neural network model for forward propagation, and the gradient of the output feature map of its initial last layer is recorded; next, for the selected quantization target of each of the layers, the current bit width thereof is increased to an adjacent larger bit width, and the other layers are kept unchanged, then the training data is input to the quantized neural network model with the increased bit width for forward propagation, and the gradient of the output feature map of the its corresponding new last layer is recorded; finally, the sensitivity of the quantization target of each of the layers is measured by a change of gradient of the network output before and after the bit width change. The smaller the change of gradient is, it indicates that the lower the sensitivity of the effect on the network output by the quantization target of this layer.

Step S4060: increasing the bit width of the quantization target of the highest sensitivity layer, and generating a new quantized neural network model.

In this step, first, the sensitivities calculated by each of the layers are sorted, and the layer with the highest sensitivity is selected; then, the bit width of the quantization target of the highest sensitivity layer is increased to the adjacent larger bit width, so as to obtain a new quantized neural network model.

Step S4070: determining whether the current quantized neural network model exceeds an upper limit of a model cost.

In this step, the model cost may be a calculation amount magnitude, a parameter amount magnitude, and so on of the quantized neural network. In a case that the current quantized neural network exceeds the upper limit of the model cost, the bit width search process ends, which indicates that the quantized neural network model that meets the condition and has the higher performance as possible has been obtained by the previous search, and the process proceeds to step S4090; otherwise, the process proceeds to step S4080 to continue the search process. A filter weight quantization bit width and a feature map quantization bit width may be obtained in this step, or may be obtained according to a random algorithm or a preset method by repeating(cycling) steps S4040 to S4060 a plurality of times.

Step S4080: fine-tuning the current quantized neural network model using the training database.

In this step, a part of a training set data is selected, and the current quantized neural network model is iteratively trained to achieve the purpose of fine-tuning its parameters.

Step S4090: retraining the obtained quantized neural network model using the training database.

In this step, when the quantized neural network satisfying the requirements has been searched out, the searched out neural network model is retrained according to the specific task requirement and all the training set data until the network converges or the exit condition is satisfied.

With the solution of the present exemplary embodiment, it is possible to gradually search out the network structure that is as small as possible and satisfies the precision requirement while keeping the precision improvement as large as possible.

### Modification 2

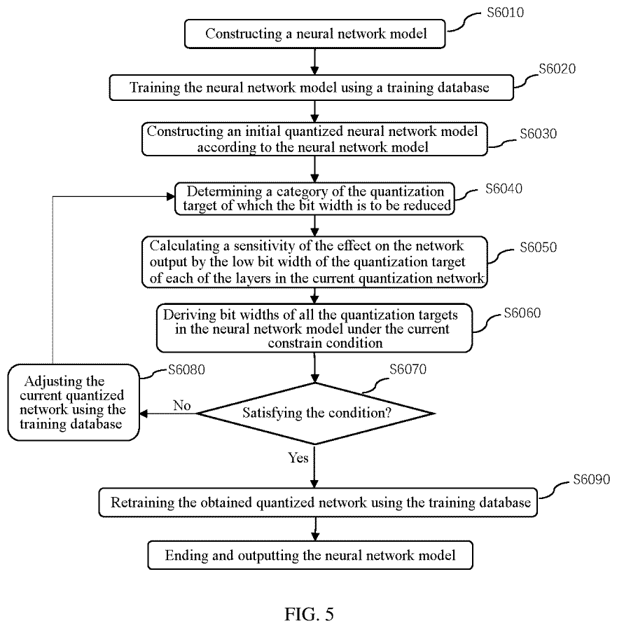

The training method of the neural network model in this exemplary embodiment will be described below with reference to FIG. 5. This exemplary embodiment shows the main workflow of searching for a neural network model with a smaller bit width of the present disclosure.

Referring to FIG. 5, the training method is described in detail below.

Step S6010: similarly to step S2010, constructing a neural network model.

Step S6020: similarly to step S2020, training the neural network model generated in step S6010 using the training database.

Step S6030: similarly to step S2030, constructing an initial quantized neural network model according to the neural network model trained in step S6020.

Step S6040: similarly to step S2040, determining a category of the quantization target of which the bit width is to be reduced.

Step S6050: similarly to step S2050, calculating a sensitivity of the effect on the network output by the low bit width of the quantization target of each of the layers in the current quantized neural network model.

Step S6060: deriving bit widths of all the quantization targets in the neural network model under the current constraint condition. (the current constraint condition is specified, and the bit widths of all the quantization targets in the neural network model are derived using an integer linear programming algorithm).

In this step, first, the current constraint condition and the bit width search space are calculated according to the search process. The search space of each of the layers in the neural network is a subset of the original search space with the currently searched out bit width as the upper limit, that is, candidate bit widths higher than the currently searched out bit width in the initial search space are removed. Under the current constraint condition, with the optimization target of maximizing the performance of the neural network model (minimizing the network quantization sensitivity), the bit width of the quantization target of each of the layers is derived using the integer linear programming algorithm. For the first search process, the current bit width search space is the original bit width search space itself.

Step S6070: determining whether the current quantized neural network model satisfies the task target.

In this step, the task target may be a calculation amount magnitude, a parameter amount magnitude, and so on of the quantized neural network, and specifically, the number of floating-point operations, the total amount of computational consumption, the total amount of memory consumption, a hardware constraint, a training cost, and so on of the current quantized neural network model. In a case that the current quantized neural network model satisfies the task target, the bit width search process ends, which indicates that a quantized neural network satisfying the condition has been searched out, and the process proceeds to step S6090. Otherwise, the process proceeds to step S6080 to repeat(cycle) the search process. A filter weight quantization bit width and a feature map quantization bit width may be obtained in this step, or may be obtained according to a random algorithm or a preset method by repeating(cycling) steps S6080 to S6090 a plurality of times.

Step S6080: adjusting the current quantized neural network model using the training database.

In this step, a part of a training set data is selected, and the current quantized neural network is iteratively trained to achieve the purpose of fine-tuning its parameters.

Step S6090: retraining the quantized neural network model using the training database.

In this step, when the quantized neural network model satisfying the task target has been obtained, the searched out neural network model is retrained according to the specific task requirement and all the training set data, until the network converges or the exit condition is satisfied.

With the solution of the present exemplary embodiment, a high-accuracy quantized neural network model satisfying the computational overhead constraint can be searched out.

Table 4 to Table 6 are are comparisons of technical effects of validation for a classification task on an ImageNet training/evaluation set of the method according to the present exemplary embodiment and the prior art (LIMPQ), the validation being performed using a convolutional neural network architecture RestNet18. Table 4 is a comparison of results for the accuracy for a generic data set of the prior art and the method according to exemplary embodiments of the present disclosure.

TABLE 4

| | Top-1 | Top-5 | Compression Ratio |
|---|---|---|---|
| LIMPQ | 64.291 | 85.755 | 12.64 |
| Method of Present | 64.532 | 85.890 | 12.67 |
| embodiment | | | |

Table 5 is a comparison of bit widths of feature maps of the neural network model obtained according to the prior art and the method of the exemplary embodiment of the present disclosure.

TABLE 5

| | Bit Widths of Feature Maps of the searched |
|---|---|
| | out Model |
| LIMPQ | 3, 3, 3, 3, 3, 3, 4, 3, 3, 3, 3, 3, 3, 3, 3, |
| | 3, 3, 3, 2 |
| Method of Present | 3, 3, 3, 3, 3, 3, 3, 3, 3, 3, 3, 3, 3, 3, 3, |
| embodiment | 3, 3, 3, 3 |

Table 6 is a comparison of bit widths of filters of the neural network model obtained according to the prior art and the method of the exemplary embodiment of the present disclosure.

TABLE 6

| | Comparison of Bit Widths of Filters of the |
|---|---|
| | searched out Model |
| LIMPQ | 3, 3, 3, 3, 3, 3, 5, 3, 3, 3, 3, 4, 3, 3, 2, |
| | 2, 4, 2, 2 |
| Method of Present | 4, 3, 4, 3, 3, 3, 4, 3, 3, 3, 3, 4, 3, 3, 2, |
| embodiment | 2, 3, 2, 2 |

### Second Exemplary Embodiment

Based on the above-described first exemplary embodiment, the second exemplary embodiment of the present disclosure describes a network model training system, including a terminal, a communication network, and a server. The terminal and the server perform communication via the communication network. The server trains a network model stored in the terminal online with a network model stored locally, such that the terminal is capable of carrying out real-time businesses using the trained network model. Various parts of the training system according to the second exemplary embodiment of the present disclosure are described below.

The terminal in the training system may be an embedded image collection device such as a security camera, and may alternatively be a device such as a smartphone, a PAD, etc. Of course, the terminal may not be a terminal such as an embedded device of relatively low computational capabilities, but is other terminals of relatively high computational capabilities. The number of the terminals in the training system may be determined according to the actual needs. For instance, if the training system is for training security cameras in a shopping mall, all security cameras in the shopping mall may be deemed as terminals. In that case, the number of the terminals in the training system is fixed. For another instance, if the training system is for training smartphones of users in the shopping mall, all smartphones accessed to the wireless local network of the shopping mall may be deemed as terminals. In that case, the number of the terminals in the training system is not fixed. The second exemplary embodiment of the present disclosure does not limit the type and the number of the terminals in the training system as long as the terminal is capable of storing and training a network model.

The server in the training system may be a high-performance server of relatively high computational capabilities, such as a cloud server. The number of the servers in the training system may be determined according to the number of terminals to be served. For example, if the number of terminals to be trained in the training system is relatively small or the geographical range in which the terminals are distributed is relatively small, the number of servers in the training system may be smaller; for example, there may be only one server. If the number of terminals to the trained in the training system is relatively large or the geographical range in which the terminals are distributed is relatively large, the number of servers in the training system may be larger; for example, a server cluster is established. The second exemplary embodiment of the present disclosure does not limit the type and the number of the servers in the training system as long as the server is capable of storing at least one network model and providing information for training the network model stored in the terminal.

The communication network in the second exemplary embodiment of the present disclosure is a wireless network or wired network realizing information transmission between the terminal and the server. All networks currently available in up/downlink transmission between network servers and terminals may be used as the communication network in this embodiment. The second exemplary embodiment of the present disclosure does not limit the type and the communication method of the communication network. Of course, the second exemplary embodiment of the present disclosure is not restricted to any other communication method. For example, a third-party storage region may be allocated to the training system. When information is to be transmitted by either of the terminal and the server to the other, the information to be transmitted is stored in the third-party storage region. The terminal and the server read information in the third-party storage region at regular times to realize information transmission therebetween.

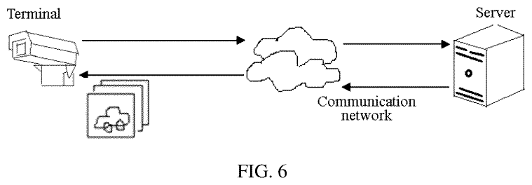

With reference to FIG. 6, the online training process of the training system according to the second exemplary embodiment of the present disclosure is described in details. FIG. 6 illustrates an example of the training system. The training system is assumed to include a terminal and a server. The terminal is capable of real-time photographing. It is assumed that the terminal stores a network model which can be trained and can process images, and the server stores the same network model. The training process of the training system is described below.

Step S201: the terminal initiates a training request to the server via the communication network.

The terminal initiates a training request to the server via the communication network. The request includes information such as a terminal identifier and the like. The terminal identifier is information uniquely representing the identity of the terminal (e.g., ID or IP address of the terminal and the like).

The above step S201 is explained with an example in which one terminal initiates the training request. Of course a plurality of terminals may initiate training requests in parallel. The processes of a plurality of terminals are similar to the process of one terminal, and are thus not redundantly described herein.

Step S202: the server receives the training request.

The training system shown in FIG. 6 includes only one server. Therefore, the communication network may transmit the training request initiated by the terminal to the server. If the training system includes a plurality of servers, the training request may be transmitted to a relatively idle server in view of the idleness of the servers.

Step S203: the server responds to the received training request.

The server determines the terminal initiating the request according to the terminal identifier included in the received training request, to determine the network model to be trained stored in the terminal. An option is that the server determines the network model to be trained stored in the terminal initiating the request according to a comparison table of the terminals and the network models to be trained. Another option is that the training request includes information of the network model to be trained, and the server may determine the network model to be trained according to the information. Here, determining the network model to be trained includes, but is not limited to, determining information characterizing the network model, such as a network architecture, a hyperparameter of the network model, and the like.

When the server determines the network model to be trained, the method of the first exemplary embodiment of the present disclosure may be used to train the network model stored in the terminal initiating the request using the same network model stored locally in the server. Specifically, according to step S2010 to step S2090 in the method of the first exemplary embodiment, the server updates the weights in the network model locally, and transmits the updated weights to the terminal so that the terminal synchronizes the network model to be trained stored in the terminal based on the received updated weights. Here, the network model in the server and the network model to be trained in the terminal may be the same network model; or the network model in the server may be more complicated than the network model in the terminal, but the two have close outputs. The present disclosure does not limit the type of the network model for training in the server and the network model to be trained in the terminal as long as the updated weights output from the server can make the network models in the terminal synchronized, such that the outputs by the synchronized network models in the terminal become closer to the expected output.

In the training system shown in FIG. 6, the terminal initiates the training request actively. Optionally, the second exemplary embodiment of the present disclosure is not limited to broadcasting inquiry information by the server and then responding to the inquiry information by the terminal for the above-described training process.

By the training system according to the second exemplary embodiment of the present disclosure, the server can train the network model in the terminal online, improving the flexibility of the training while greatly improving the capability of the terminal to handle businesses and expanding business handling scenarios of the terminal. In the second exemplary embodiment, the training system is described above with online training as an example. However, the present disclosure is not limited to the offline training process, which is not redundantly described herein.

### Third Exemplary Embodiment

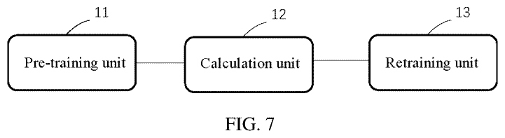

The third exemplary embodiment of the present disclosure describes a training apparatus of a neural network model. The apparatus can execute the training method described in the first exemplary embodiment. Moreover, when applied to an online training system, the apparatus may be an apparatus in the server described in the third exemplary embodiment. The software structure of the apparatus will be described in detail below with reference to FIG. 7.

The training apparatus in the present third exemplary embodiment includes a pre-training unit 11, a calculation unit 12, and a retraining unit 13. The pre-training unit 11 is configured to pre-train the neural network model, wherein the neural network model comprises at least one quantization unit, wherein each of the quantization units contains a plurality of different quantization bit widths; the calculation unit 12 is configured to calculate sensitivities of the quantization units, and based on the calculated sensitivities adjust an optimal bit width of each of the quantization units and adjust quantization parameters, thereby generating a mixed-precision neural network model; the retraining unit 13 is configured to retrain the generated mixed-precision neural network model.

The training apparatus of this embodiment further includes modules for realizing the functions of the server in the training system, such as the functions of identifying received data, data packaging, network communication, etc., which are not redundantly described herein.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The embodiments of the present disclosure may also be implemented by a method of providing the software (program) that executes the functions of the above-mentioned embodiments to a system or device via a network or various storage media, where a computer or a Central Processing Unit (CPU) or a microprocessor unit (MPU) of this system or device reads out and executes the program.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and function

What is claimed is:

1. A method for training a neural network model, the method comprising:
performing a pre-training step to pre-train the neural network model so that the neural network model includes at least one quantization unit, wherein each quantization unit contains a plurality of different quantization bit widths;
calculating a sensitivity of the quantization unit;
updating the quantization bit width of each quantization unit and updating a quantization parameter based on the calculated sensitivity;
generating a mixed-precision neural network model, wherein the sensitivity indicates the extent to which the quantization bit width of the quantization unit affects a network output; and
retraining the generated mixed-precision neural network model.

2. The method according to claim 1, wherein each of the quantization units includes a filter weight quantization unit and a feature map quantization unit.

3. The method according to claim 1, wherein the calculating a sensitivity comprises:
Performing a measuring step of calculating the sensitivity of each quantization unit; and
performing updating step of reducing a bit width of the quantization unit with low sensitivity in the neural network model or increasing the bit width of the quantization unit with high sensitivity in the neural network model.

4. The method according to claim 3, wherein in a case that the neural network model updated in the updating step does not satisfy a predetermined condition, an output of this step is input to the measuring step, and the measuring step and the updating step are cycled until the predetermined condition is satisfied.

5. The method according to claim 4, wherein performing the measuring step includes obtaining the bit widths of a filter weight quantization unit and a feature map quantization unit and the updating step performed for a first time, or can be obtained according to a random algorithm or a preset method in the measuring steps and the updating steps cycled a plurality of times.

6. The method according to claim 1,
performing the pre-training step, for each quantization unit, selecting, buy a randomization algorithm or a preset method, one bit width for quantizing an input during forward propagation.

7. The method according to claim 3, wherein
in the updating step, the quantization unit can have a maximum bit width or a minimum bit width.

8. The method according to claim 3, wherein the measuring of the sensitivity includes single-shot network pruning, gradient signal preservation, synaptic flow pruning, Fisher information, batch normalization scale factor, L2 norm, and Jacobian determinant.

9. The method according to claim 3, wherein the sensitivities of the quantization units are sorted.

10. The method according to claim 3, wherein performing the updating step includes reducing a current bit width to an adjacent smaller bit width or increasing the current bit width to an adjacent larger bit width.

11. The method according to claim 3, wherein the quantization unit with low sensitivity or the quantization unit with high sensitivity can be obtained by methods including a sorting algorithm and an integer programming algorithm.

12. The method according to claim 11, wherein constraint conditions of the integer programming algorithm include a global target constraint condition and a current search stage constraint condition, wherein the current search stage constraint condition can be obtained based on inclusion of the global target constraint condition and a current number of searches.

13. The method according to claim 4, wherein the predetermined condition includes a number of floating-point operations, a total amount of computation consumption, a total amount of memory consumption, a hardware constrain, and a training cost of a currently quantized neural network model.

14. The method according to claim 3, wherein the sensitivity can be normalized by a predetermined indicator including one or more a number of floating-point operations, a number of multiply-accumulate operations, a total amount of memory consumption, a total amount of computation consumption.

15. A apparatus for training a neural network model comprising:
a pre-training unit configured to pre-train the neural network model, wherein the neural network model includes at least one quantization unit, wherein each quantization unit contains a plurality of different quantization bit widths;
a calculation unit configured to calculate a sensitivity of the quantization unit, and based on the calculated sensitivity update an optimal quantization bit width of each quantization unit and update a quantization parameter, thereby generating a mixed-precision neural network model, wherein the sensitivity indicates the extent to which the quantization bit width of the quantization unit affects a network output; and
a retraining unit configured to retrain the generated mixed-precision neural network model.

16. A non-transitory computer-readable storage medium storing instructions which, when executed by a computer, cause the computer to perform the method for training a neural network model according to claim 1.
